(19) United States
(12) Patent Application Publication
(10) Pub. No.: US 2025/0147933 A1
(43) Pub. Date: May 8, 2025

(54) SETUP SUPPORT SYSTEM, SETUP SUPPORT METHOD, AND INFORMATION STORAGE MEDIUM

(71) Applicants: Cybozu, Inc., Tokyo (JP); Cybozu Labs, Inc., Tokyo (JP)

(72) Inventors: Naoki TATEYAMA, Tokyo (JP); Shuyo NAKATANI, Tokyo (JP)

(21) Appl. No.: 18/916,725

(22) Filed: Oct. 16, 2024

(30) Foreign Application Priority Data
Nov. 6, 2023 (JP) 2023-189430

(51) Int. Cl. G06F 16/21; G06F 16/25; G06F 16/28

(52) U.S. Cl. CPC G06F 16/211; G06F 16/258; G06F 16/285

(57) ABSTRACT

Provided is a setup support system including at least one processor, the at least one processor being configured to: identify a setting operation performed by a user in order to set a setting of a database to be created with no-code or low-code; and support setting up of the database by the user based on the setting operation and a machine learning model which has learned training data created based on a setting for training.

### CROSS-REFERENCE TO RELATED APPLICATION

The present disclosure contains subject matter related to that disclosed in Japanese Patent Application JP 2023-189430 filed in the Japan Patent Office on Nov. 6, 2023, the entire contents of which are hereby incorporated by reference.

### BACKGROUND OF THE INVENTION

### 1. Field of the Invention

The present disclosure relates to a setup support system, a setup support method, and an information storage medium.

### 2. Description of the Related Art

Hitherto, there has been known databases created with no-code or low-code. For example, in Non-Patent Literature 1 (“What is an app?” Internet, retrieved Oct. 26, 2023, online, https://jp.cybozu.help/k/ja/user/basic/app_tutorial.html), a help page of an app, which is an example of a database created with no-code or low-code, is described. In the app of “What is an app?,” the user can freely specify settings for fields and the like. The user can also change the settings of a sample app prepared in advance in accordance with his or her own preferences.

However, in the app of “What is an app?,” there may be cases in which the user does not know what settings to specify. For example, the user may find it difficult to specify field types, which are the types of the fields in the app. This point is not limited to the app of “What is an app?,” and also applies to other databases created with no-code or low-code. Databases created with no-code or low-code are easy for a user to use, but the user may not know what settings to specify. For this reason, there is a need to support a user who is setting up a database to be created with no-code or low-code.

### SUMMARY OF THE INVENTION

One object of the present disclosure is to support setting up of a database to be created with no-code or low-code.

According to at least one aspect of the present disclosure, there is provided a setup support system including at least one processor, the at least one processor being configured to: identify a setting operation performed by a user in order to set a setting of a database to be created with no-code or low-code; and support setting up of the database by the user based on the setting operation and a machine learning model which has learned training data created based on a setting for training.

### BRIEF DESCRIPTION OF THE DRAWINGS

FIG. 1 is a diagram for illustrating an example of a hardware configuration of a setup support system.

FIG. 2 is a diagram for illustrating an example of an app screen.

FIG. 3 is a diagram illustrating an example of a setting screen.

FIG. 4 is a diagram for illustrating an example of a setting screen.

FIG. 5 is a diagram for illustrating an example of functions implemented by the setup support system.

FIG. 6 is a table for showing an example of a training database.

FIG. 7 is a table for showing an example of a topic database.

FIG. 8 is a table for showing an example of an app database.

FIG. 9 is a flow chart for illustrating an example of processing executed by the setup support system.

FIG. 10 is a diagram for illustrating an example of functions implemented by a setup support system of modification examples.

FIG. 11 is a diagram for illustrating an example of a setting screen in Modification Example 2.

FIG. 12 is a diagram for illustrating an example of processing executed by a setup support system of Modification Example 4.

### DESCRIPTION OF THE EMBODIMENTS

### 1. Hardware Configuration

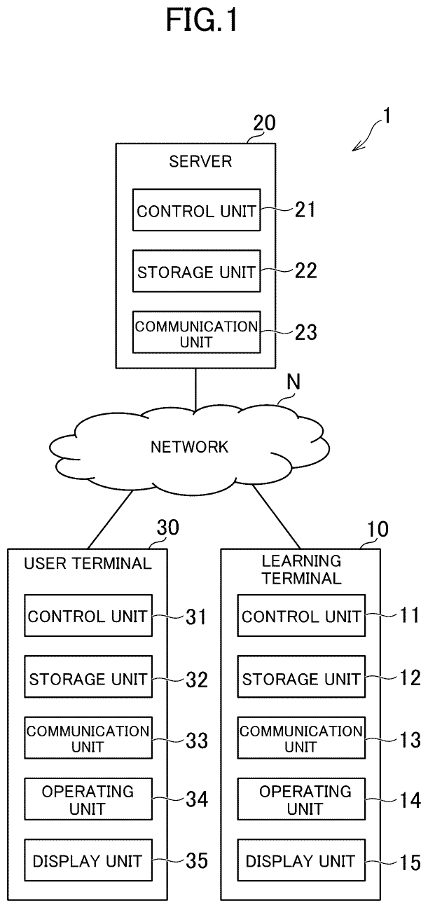

An example of a setup support system, a setup support method, and a program according to at least one embodiment of the present disclosure is described. FIG. 1 is a diagram for illustrating an example of a hardware configuration of the setup support system. For example, a setup support system 1 includes a learning terminal 10, a server 20, and a user terminal 30. The learning terminal 10, the server 20, and the user terminal 30 are each connected to a network N, such as the Internet or a LAN.

The learning terminal 10 is a computer which trains a machine learning model described later. For example, the learning terminal 10 is a personal computer, a tablet terminal, or a smartphone. For example, the learning terminal 10 includes a control unit 11, a storage unit 12, a communication unit 13, an operating unit 14, and a display unit 15. The control unit 11 includes at least one processor. The storage unit 12 includes at least one of a volatile memory such as a RAM or a non-volatile memory such as a flash memory. The communication unit 13 includes at least one of a communication interface for wired communication or a communication interface for wireless communication. The operating unit 14 is an input device, such as a mouse or a touch panel. The display unit 15 is a liquid crystal display or an organic EL display.

The server 20 is a server computer. For example, the server 20 includes a control unit 21, a storage unit 22, and a communication unit 23. Hardware configurations of the control unit 21, the storage unit 22, and the communication unit 23 may be the same as those of the control unit 11, the storage unit 12, and the communication unit 13, respectively.

The user terminal 30 is a computer of a user. For example, the user terminal 30 is a personal computer, a tablet terminal, or a smartphone. For example, the user terminal 30 includes a control unit 31, a storage unit 32, a communication unit 33, an operating unit 34, and a display unit 35. Hardware configurations of the control unit 31, the storage unit 32, the communication unit 33, the operating unit 34, and the display unit 35 may be the same as those of the control unit 11, the storage unit 12, the communication unit 13, the operating unit 14, and the display unit 15, respectively.

Programs stored in the storage units 12, 22, and 32 may be supplied through the network N. Hardware configurations of the learning terminal 10, the server 20, and the user terminal 30 are not limited to the examples of FIG. 1. For example, at least one of the learning terminal 10, the server 20, or the user terminal 30 may include at least one of a reading unit (for example, memory card slot) for reading a computer-readable information storage medium or an input/output unit (for example,

USB terminal) for directly connecting to an external device. Programs stored in the information storage medium may be supplied through intermediation of at least one of the reading unit or the input/output unit to at least one of the learning terminal 10, the server 20, or the user terminal 30.

Further, the setup support system 1 is only required to include at least one computer. The computers included in the setup support system 1 are not limited to the example of FIG. 1. For example, the setup support system 1 may include only the learning terminal 10 and the server 20. In this case, the user terminal 30 exists outside the setup support system 1. The setup support system 1 may include only the server 20. In this case, the learning terminal 10 and the user terminal 30 exist outside the setup support system 1. The setup support system 1 may include the server 20 and another server computer.

### 2. Outline of Setup Support System

In the at least one embodiment, the user sets up a database to be created with no-code or low-code. A database created with no-code is a database that does not require the user to input code in a database language or a programming language in the database development platform. For example, when the user specifies the database settings, the setup support system 1 creates a database based on those settings. All of the code required for creation of the database is provided by the setup support system 1.

A database created with low-code is a database that requires the user only to input the minimum amount of code that is required for the database development platform. For example, when the user inputs the minimum required code and specifies the database settings, the setup support system 1 creates a database based on the minimum required code and those settings. The remaining code required for creation of the database is provided by the setup support system 1.

It is noted that a person skilled in the art who is involved in database development would be able to understand the meaning of no-code and low-code based on the common general technical knowledge at the time of filing. Each of the terms “no-code” and “low-code” may have a publicly-known meaning that can be understood by a person skilled in the art based on the common general technical knowledge at the time of filing. In the following description, the term “database” refers to a database to be created with no-code or low-code. “Database creation” can also be referred to as database “development” or “construction.”

In the at least one embodiment, a case in which a groupware app corresponds to a database is given as an example. Groupware is a program which supports tasks by a user. Groupware may be any one of cloud-based groupware or on-premises groupware. The app not only functions as a database, but also has other functions relating to task support. For example, the app has at least one of a communication function, a file management function, an email management function, or another function. The functions that the app has may be publicly-known functions. In the following description, “app” may be read as “database.” In the at least one embodiment, a case in which an app is created with no-code is given as an example, but the app may be created with low-code. For example, when the user logs in to the groupware, the user can use the apps of an organization such as a company to which he or she belongs. When the user selects a given app, the user terminal 30 displays an app screen showing the app on the display unit 35.

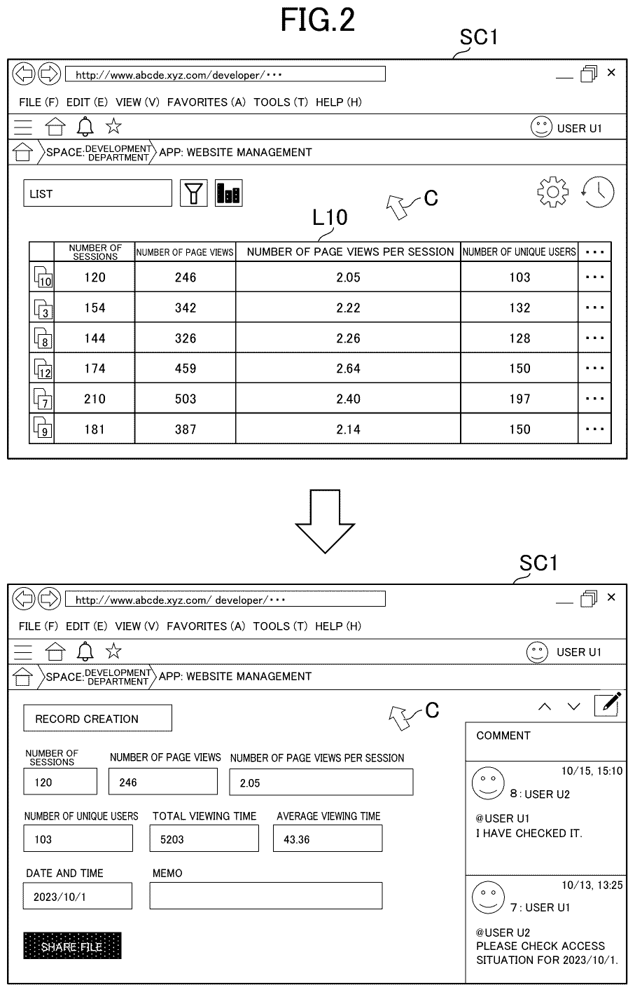

FIG. 2 is a diagram for illustrating an example of an app screen. In the at least one embodiment, as an example of the app, an app which manages access to a website is described. For example, as illustrated in the upper part of FIG. 2, an app screen SC1 includes a record list L10 showing a list of records, which are each a single data unit in the app. The record list L10 shows the values of fields, which are each a single item forming a record. “Field” may also be referred to by another name, such as “cell.” The first row of the record list L10 indicates a field name, which is the name of the field.

For example, when the user selects a given record from the record list L10, as illustrated in the lower part of FIG. 2, the user terminal 30 displays an app screen SC1 showing details of the record on the display unit 35. The user can input a value corresponding to a field type, which is the type of the field in the record, from the app screen SC1 of the lower part of FIG. 2.

“Field type” can also be referred to as “data type of the field.” The field type may be a type used in a publicly-known app. For example, the field type may be a numerical value, a calculation, a character string (single line), a character string (multiple lines), a date and time, a link, or a lookup.

For example, the field type of each of the fields having the field name “number of sessions” and the field name “number of page views” is a numerical value. The user can input any numerical value in those fields. The field type of the field having the field name “number of page views per session” is a calculation. In that a calculation formula which indicates that the numerical value input in the field having the field name “number of page views” is divided by the numerical value input in the field having the field name “number of sessions” is set. Some sort of field type is also defined for the other fields.

In the at least one embodiment, the setup support system 1 supports the user creating the app of FIG. 2 to set up the app. In the following description, it is assumed that the app of FIG. 2 has not yet been created. That is, it is assumed that the user is about to newly create the app of FIG. 2. For example, when the user logs in to the groupware and performs an operation for creating an app, the user terminal 30 displays a setting screen for the user to specify the app settings on the display unit 35.

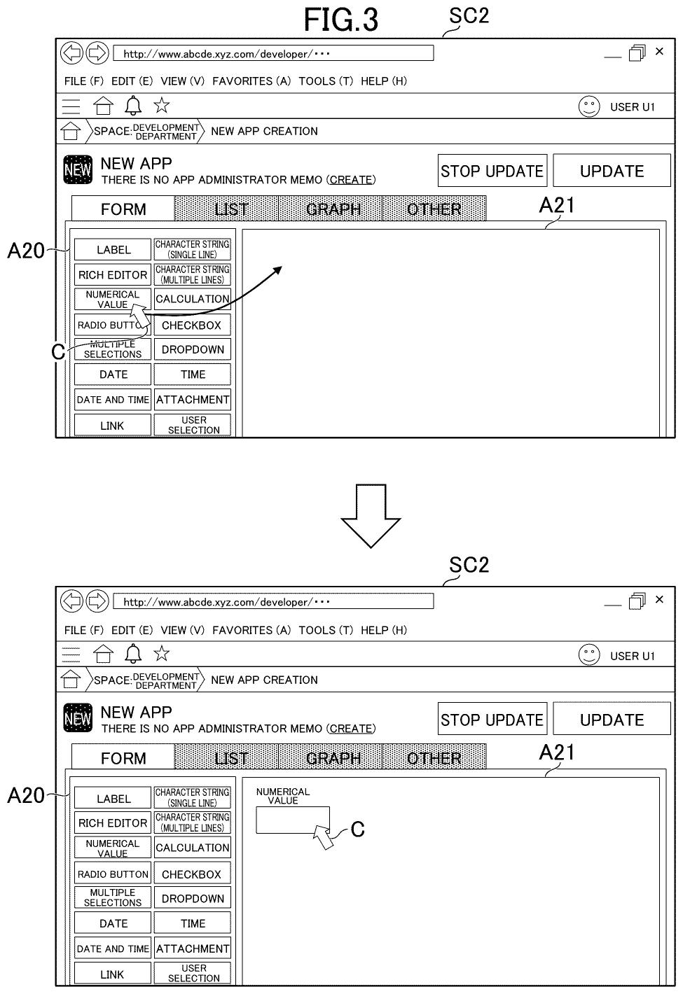

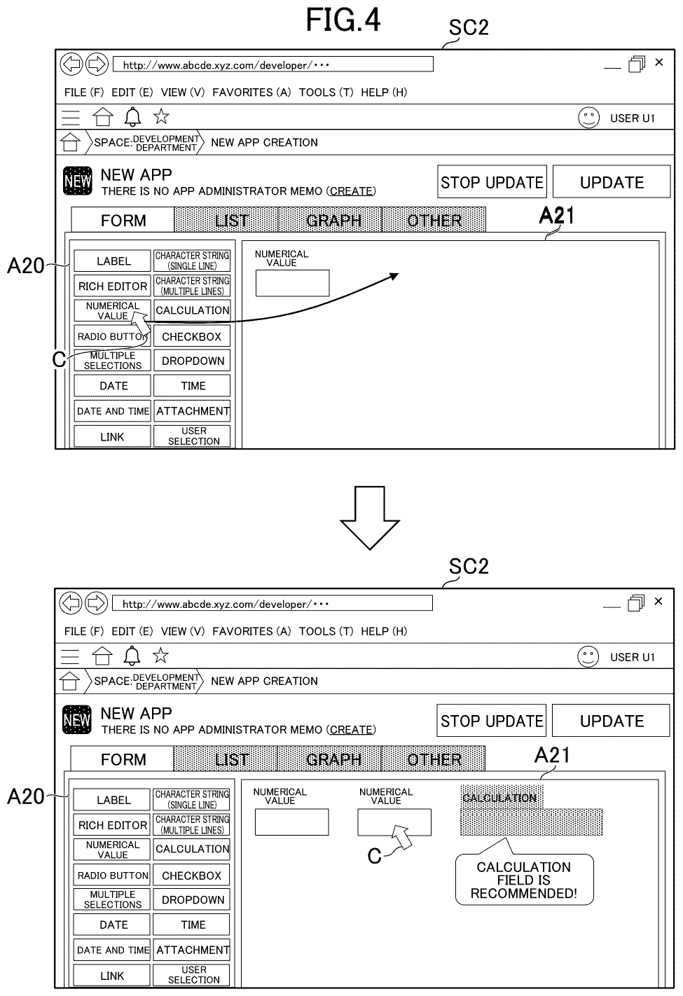

FIG. 3 and FIG. 4 are diagrams for illustrating an example of setting screens. For example, a setting screen SC2 includes a display area A20 showing a list of forms that the user can place on the app screen SC1. Through moving an image displayed in the display area A20 to a display area A21 with a cursor C, the user can specify the field of the field type indicated by the image. From the setting screen SC2, the user can specify settings other than the field type (for example, field name, form layout, form width, graph, or access privilege settings).

In the following description, the setting of a field is referred to as “field setting.” When it is not required to distinguish between a field setting and the settings other than a field setting, field setting and the settings other than the field setting are simply referred to as “setting.” For example, as illustrated in the upper part of FIG. 3, when the user moves the image indicating the field type “numerical value” from the display area A20 to the display area A21, as illustrated in the lower part of FIG. 3, the form of the field having the field type “numerical value” is placed in the display area A21. The layout of the form of the display area A21 becomes the layout of the form of the app screen SC1 of the lower part of FIG. 2. The user moves images one after another from the display area A20 to the display area A21 to achieve the desired settings.

In the at least one embodiment, the setup support system 1 supports the user in the setting up of an app based on a machine learning model which has learned the settings of a training app. The details of the learning method of the machine learning model are described later. Here, it is assumed that the machine learning model has learned the field settings of the training app. For example, the machine learning model predicts the field type in which the user is going to place a form next based on the field types of the forms that the user has placed in the display area A21.

For example, as illustrated in the upper part of FIG. 4, the user moves the image indicating the field type “numerical value” from the display area A20 to the display area A21. When two fields of the field type “numerical value” exist, the machine learning model predicts the field type (recommended field type) in which the user is to place a form next. When the machine learning model predicts that the user is going to place a form having the field type “calculation” next, as illustrated in the lower part of FIG. 4, the user terminal 30 uses a placeholder function to place a form having the field type “calculation” in the display area A21. The user terminal 30 may display a message suggesting that form in the display area A21.

For example, when the user selects a form having the field type “calculation” displayed in the display area A21, the user terminal 30 places that form in the display area A21. When the user does not select a form having the field type “calculation” displayed in the display area A21, the user terminal 30 deletes that form from the display area A21. When a message suggesting that form is displayed in the display area A21, the user terminal 30 deletes the message.

For example, each time the user specifies some sort of setting of an app or deletes some sort of setting of an app, the machine learning model predicts the setting to be specified by the user next based on the settings of the training app that the machine learning model has learned. The user terminal 30 displays the result of prediction by the machine learning model on the setting screen SC2 until the user completes the settings for the app being created. The setup support system 1 of the at least one embodiment can support the user to set up the app based on such a machine learning model. Details of the setup support system 1 are described below.

### 3. Functions implemented by Setup Support System

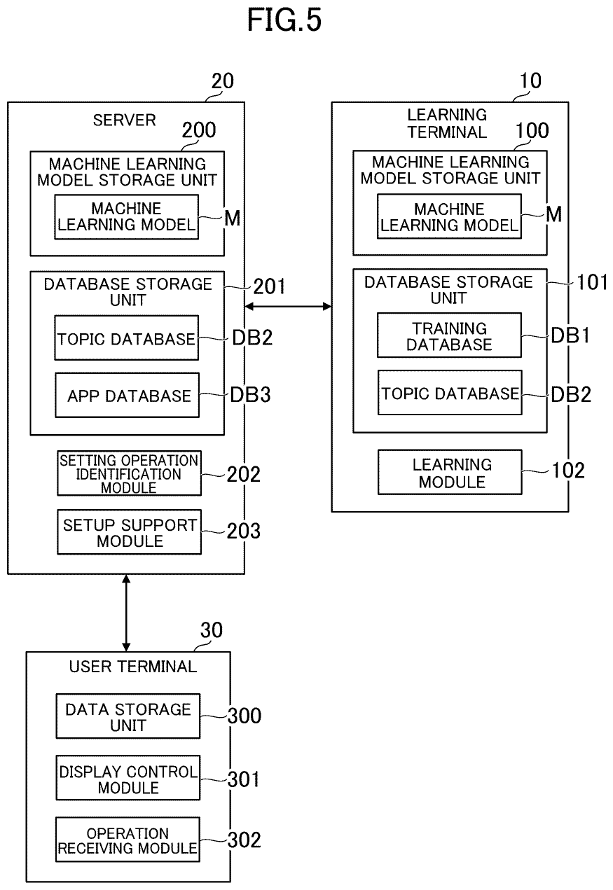

FIG. 5 is a diagram n for illustrating an example of functions implemented by the setup support system 1.

### 3-1 Functions implemented by Learning Terminal

For example, the learning terminal 10 includes a machine learning model storage unit 100, a database storage unit 101, and a learning module 102. The machine learning model storage unit 100 and the database storage unit 101 are implemented by the storage unit 12. The learning module 102 is implemented by the control unit 11.

### Machine Learning Model Storage Unit

The machine learning model storage unit 100 stores machine learning model M. The machine learning model M is a model created based on a machine learning method. The machine learning model M may be any type of model. For example, the machine learning model M may be any of a supervised learning model, a semi-supervised learning model, or an unsupervised learning model.

In the at least one embodiment, a case in which the machine learning model M is a model created by a latent Dirichlet allocation (LDA) method is given as an example. LDA is a type of topic model that is mainly used for the purpose of clustering. A topic model is a model for identifying the topic of a sentence. The topic model executes clustering so that sentences on the same topic belong to the same cluster. A cluster itself may also be referred to as “topic.” The topic model may be a model using a publicly-known method. The machine learning model M may be a topic model other than LDA. For example, the machine learning model M may be a model created by a latent semantic analysis (LSA) method, a non-negative matrix factorization (NMF) method, or a hierarchical Dirichlet process (HDP) method.

The machine learning model M is not limited to a topic model. For example, the machine learning model M may be of various types of publicly-known machine learning models. In the at least one embodiment, the machine learning model M is used for clustering, and thus the machine learning model M may be created by another method used for clustering. For example, the machine learning model M may be a model created by using k-means clustering, hierarchical clustering, density-based spatial clustering of applications with noise (DBSCAN), or another method. For example, the machine learning model M may be a neural network. The machine learning model M may execute processing other than clustering. An example of other processing is described in modification examples described later.

For example, the machine learning model M includes parameters that are adjusted through learning and a program for calculating embedded expressions, for example. The parameters of the machine learning model M are referred to by the program of the machine learning model M. Examples of the parameters include a weighting factor and a bias. The program of the machine learning model M includes code indicating internal processing of the machine learning model M. For example, the program of the machine learning model M includes an intermediate layer which calculates an embedded expression and generates data for an output layer, and an output layer that performs final output based on the data. The program and parameters of the machine learning model M may be various publicly-known programs and parameters. The machine learning model storage unit 100 may store other data such as a learning program indicating a series of processing steps during learning. It is assumed that a calculation formula for a loss function to be calculated during learning is also shown in the learning program.

### Database Storage Unit

The database storage unit 101 stores data required for training the machine learning model M. For example, the database storage unit 101 also stores a training database DB1 required for learning and a topic database DB2 acquired as a result of learning.

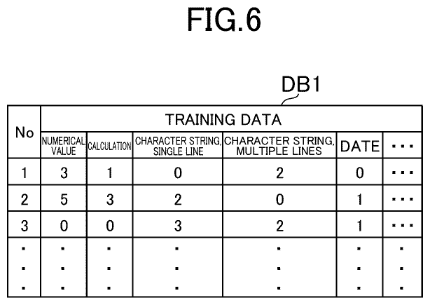

FIG. 6 is a table for showing an example of the training database DB1. The training database DB1 is a database in which training data required for training the machine learning model M is stored. In the at least one embodiment, the machine learning model M is based on LDA, which is a type of unsupervised learning, and it is assumed that the training data is not annotated. When a supervised learning or semi-supervised learning machine learning model M is used, the training data is annotated. The training data may be prepared by manual input or may be prepared by using a publicly-known tool.

For example, the training data is created based on the settings of a training app. The training app is an app used to generate training data. For example, the training app may be a virtual app prepared by a creator of the machine learning model M (for example, a staff member of the company providing the groupware to the user), or an app that is actually used in the groupware. The training data can indicate any settings of the training app. In the at least one embodiment, the training data indicates the field settings of the training app.

For example, the training data indicates each of a plurality of field types and the number of fields of those field types in the training app. That is, the training data indicates, for each field type, the number of fields of that field type in the training app. For example, when the number of field types is “n” (“n” is a natural number), the training data is expressed as an n-dimensional vector. The element of each dimension of the vector is the number of fields of the field type corresponding to that dimension.

In the example of FIG. 6, the numbers of fields of the field type “numerical value,” the field type “calculation,” the field type “character string, single line,” the field type “character string, multiple lines,” and the field type “date” in a first training app are 3, 1, 0, 2, and 0, respectively. The numbers of other field types are also shown in the training data. Similarly, in the second and subsequent training apps, the training data shows the number of fields of each field type.

The training data may have any format. The format of the training data is not limited to vectors. For example, the training data may be expressed as an array, a matrix, a combination of a plurality of numerical values, a single numerical value, a character, or another symbol. In the example of FIG. 6, the number of each field type of the fields in the training app may be indicated in the training data in another format such as an array.

Further, when the training data is annotated, the training data includes an input portion which is input to the machine learning model M during training, and an output portion which becomes a ground truth during training. The input portion and the output portion may be combined in accordance with the setting up supported by the machine learning model M. For example, the input portion of the training data shows the field settings of the training app. The output portion of the training data shows the cluster to which the training app belongs. A cluster can also be referred to as “label.”

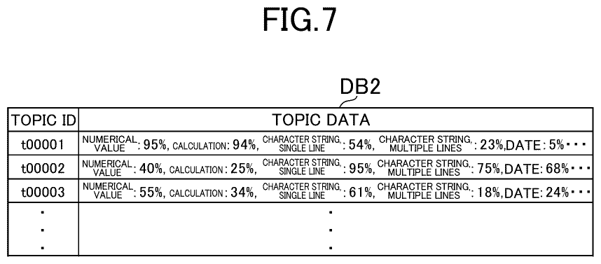

FIG. 7 is a table for showing an example of the topic database DB2. The topic database DB2 is a database in which topic data indicating individual topics acquired when the training of the machine learning model M is complete is stored. For example, the topic database DB2 stores a topic ID, which is an ID for identifying individual topics, and topic data. The number of topics may be specified by the creator of the machine learning model M, or may be determined by a program for the training of the machine learning model M.

In the example of FIG. 7, the topic data of each topic shows a usage rate of each field type in the training app belonging to the topic. The usage rate of a certain field type is the value obtained by dividing the number of training apps in which fields of that field type are used by the total number of training apps belonging to the topic. For example, when the usage rate of a certain field type is 90%, this indicates that fields of that field type are used in 90% of the training apps for the topic.

The data stored by the database storage unit 101 is not limited to the example described in the at least one embodiment. It suffices that the database storage unit 101 stores the data required for the training of the machine learning model M. For example, the database storage unit 101 may store a database in which various types of data of the training apps are stored. Data indicating the various settings of the training apps is stored in the database. Training data may be created based on the database.

### Learning Module

The learning module 102 trains the machine learning model M based on each of a plurality of pieces of training data stored in the training database DB1. In the at least one embodiment, a case in which the learning module 102 trains the machine learning model M based on an unsupervised learning algorithm is given as an example. The learning algorithm may be one of the publicly-known algorithms described above. The learning module 102 may train the machine learning model M based on a supervised learning algorithm, a semi-supervised learning algorithm, or an unsupervised learning algorithm.

For example, the learning module 102 trains the machine learning model M by adjusting parameters based on an unsupervised learning algorithm so that pieces of training data having similar features to each other belong to the same cluster. In the at least one embodiment, the learning module 102 trains the machine learning model M based on the publicly-known LDA algorithm. When a topic model other than LDA is used, the learning module 102 trains the machine learning model M based on the algorithm of another publicly-known topic model. When a machine learning method other than a topic model is used, the learning module 102 trains the machine learning model M based on the algorithm of another machine learning method.

In the at least one embodiment, the learning module 102 executes a series of processing steps for training by executing the learning program stored in the database storage unit 101. The learning module 102 records the trained machine learning model M in the database storage unit 101. The database storage unit 101 may store both the pre-trained machine learning model M and the trained machine learning model M. The learning module 102 transmits the trained machine learning model M to the server 20. The trained machine learning model M transmitted to the server 20 is made available for use by the user.

For example, the learning module 102 generates the topic database DB2 based on the processing result of the trained machine learning model M, and records the generated topic database DB2 in the database storage unit 101. The learning module 102 generates the topic database DB2 by calculating the usage rate of each field type for each topic based on the field settings of the training apps belonging to the topic. The learning module 102 transmits the topic database DB2 to the server 20. The topic database DB2 transmitted to the server 20 is made available for use by the user.

When a supervised learning or semi-supervised learning model is used, the learning module 102 may train the machine learning model M by adjusting the parameters of the machine learning model M based on the algorithm of those models so that the output portion of the training data is output from the machine learning model M when the input portion of the training data is input to the machine learning model M. For example, the learning module 102 trains the machine learning model M based on a publicly-known algorithm such as error backpropagation or gradient descent.

### 3-2. Functions Implemented by Server

For example, the server 20 includes a machine learning model storage unit 200, a database storage unit 201, a setting operation identification module 202, and a setup support module 203. Each of the machine learning model storage unit 200 and the database storage unit 201 is implemented by the storage unit 22. Each of the setting operation identification module 202 and the setup support module 203 is implemented by the control unit 21.

### Machine Learning Model Storage Unit

The machine learning model storage unit 200 stores a machine learning model M that has learned training data created based on a training setting. For example, the machine learning model storage unit 200 stores a machine learning model M for which the training executed by the learning terminal 10 is complete. The training of the machine learning model M may be executed by the server 20. In this case, the server 20 has the same function as that of the learning module.

### Database Storage Unit

The database storage unit 201 stores data required to support the setting up. For example, the database storage unit 201 stores the topic database DB2. The machine learning model storage unit 200 stores the topic database DB2 generated by the learning terminal 10. In addition to the topic database DB2, the database storage unit 201 stores an app database DB3 in which various types of data of the app are stored.

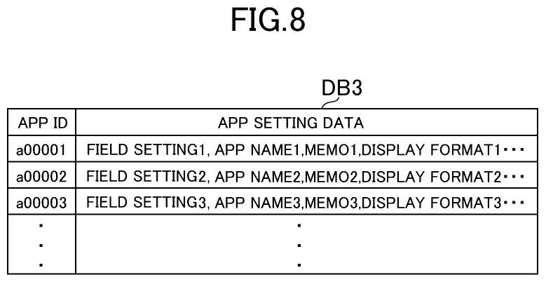

FIG. 8 is a table for showing an example of the app database DB3. For example, the app database DB3 stores an app ID, which is an ID for identifying individual apps, and app setting data which indicates the specific setting content of the app. In the app database DB3, any data may be stored, and the data stored in the app database DB3 is not limited to the example of FIG. 8. For example, in the app database DB3, record data indicating details of each record may be stored.

In the at least one embodiment, the app setting data indicates the field settings. For example, the field settings are the field types of the fields in the app. The field settings may be any setting of the field. The field settings are not limited to field type. For example, the field settings may be the field name (column name), field order (column order), form layout for users to input field values, a calculation formula set in the field, or another setting.

The app setting data is not limited to the field settings. The app setting data is only required to indicate any setting of the app. For example, the app setting data may be the app name, a memo for an app administrator, a display format of the record list L10, a setting of a graph displayed in the app, an app icon, an overall design of the app, an access privilege, or another setting. When the user creates an app, the server 20 stores the app ID of the app and the app setting data indicating the settings of the app in association with each other in the app database DB3.

The data stored in the database storage unit 201 is not limited to the above-mentioned examples. The database storage unit 201 can store any data. For example, the database storage unit 201 may store a user database in which various types of user data are stored. The user database stores data such as a user ID and password for groupware login. The database storage unit 201 may store the data of each screen such as the app screen SC1 or the setting screen SC2. For example, the database storage unit 201 may store a program to enable creation of an app with no-code or low-code. The program includes code that the user is not required to input. The app is created based on the settings specified by the user and the code of the program. The creation of the app may be performed by the server 20 or by another computer other than the server 20.

### Setting Operation Identification Module

The setting operation identification module 202 identifies setting operations performed by the user in order to set the settings of the app. A setting operation is different from the operation in which the user inputs a character string indicating code. For example, the setting operations may be an operation of selecting an image displayed on the setting screen SC2 (an image for an app setting), an operation of specifying a specific value of an app setting, or an operation in which the user inputs a character string other than code. The setting operations may be any operation relating to some sort of setting of the app.

In the at least one embodiment, a case in which the setting operations are an operation for the user to specify a setting is given as an example. That is, an operation in which the user specifies a specific setting of the app corresponds to the setting operation. Examples of other setting operations are described in the modification examples described later. For example, when the user performs a setting operation, the user terminal 30 transmits setting operation data indicating the content of the setting operation to the server 20. The server 20 receives the setting operation data from the user terminal 30. The setting operation identification module 202 identifies the setting operation by referring to the setting operation data. In the at least one embodiment, the identification of the setting operation by the setting operation identification module 202 corresponds to identifying the content of the setting specified by the user.

In the at least one embodiment, the setting operation data indicates the field setting specified in the setting operation by the user. In the examples of FIG. 3 and FIG. 4, the operation by the user to move an image indicating the form of a certain specific field type from the display area A20 to the display area A21 corresponds to the setting operation. The setting operation data indicates the field type specified by the setting operation (field type indicated by the image moved by the user from display area A20 to display area A21). The setting operation data also indicates the content of other settings such as form layout.

The setting operation may be any operation by the user on the setting screen SC2. The setting operation is not limited to an operation in which the user moves an image indicating the field type from the display area A20 to the display area A21. For example, the setting operation may be an operation in which the user inputs text indicating the field name, an operation in which the user changes the layout of the form of the field, or an operation in which the user rearranges the order of the fields. The setting operation may be an operation in which the user specifies the field settings by another method.

For example, the setting operation may be an operation in which the user specifies a setting other than a field setting. For example, the setting operation may be an operation in which the user inputs text indicating the app name, an operation in which the user inputs a memo for the administrator of the app, an operation in which the user specifies the display format of the record list L10, an operation in which the user specifies a setting of a graph displayed in the app, an operation in which the user specifies an app icon, an operation in which the user specifies the overall design of the app, an operation in which the user specifies an access privilege, or an operation in which the user specifies another setting. Even when those setting operations are performed, the setting operation data may be any data that the server 20 can use to specify what setting the user has specified by the setting operation.

### Setup Support Module

The setup support module 203 supports the setting up of the app by the user based on the setting operations identified by the setting operation identification module 202 and the machine learning model M. The setting up is work performed by the user in order to set the settings of the app. The setting operation is an example of the setting up. The user may perform another operation other than a setting operation as the setting up. For example, the another operation may be an operation of deleting a setting specified by the user, an operation of copying a created app, or an operation of deleting a created app.

As used herein, “the setup support module 203 supports setting up” means that the setup support module 203 executes processing to reduce the burden of the setting up on the user. For example, the setup support module 203 suggesting the specific content of the setting up to the user, the setup support module 203 automatically executing all or a part of the setting up, or the setup support module 203 automatically generating data indicating the app settings corresponds to the setup support module 203 supporting the setting up. In the example of the setting screen SC2 of the lower part of FIG. 4, the setup support module 203 executing display by a placeholder function and display of a message indicating the next setting up corresponds to the setup support module 203 supporting the setting up.

In the at least one embodiment, the user specifies the app settings themselves by performing the setting operation, and thus the setup support module 203 supports the setting up based on the settings specified by performing the setting operations and the machine learning model M. For example, when the setting specified by a setting operation is a field setting, the machine learning model M has learned training data created based on a field setting for training. The learning processing is as described above. In the at least one embodiment, the machine learning model M has learned training data created based on a training app.

In the at least one embodiment, the setup support module 203 supports the setting up by suggesting to the user the field setting to be specified by the next setting operation based on the field settings specified by the setting operations and the machine learning model M. The setup support module 203 suggests the field setting by displaying an indication relating to the field setting predicted by the machine learning model M in a manner that the user can visually recognize on the setting screen SC2. The information is not limited to an image of a placeholder function like that in the setting screen SC2 of the lower part of FIG. 4. For example, the information may be a message like that in the setting screen SC2 of the lower part of FIG. 4, or may be an image such as an icon. The setup support module 203 may suggest the field setting to the user by, for example, causing the image in the display area A20 to blink on and off, or some similar effect.

For example, the setup support module 203 suggests to the user the field setting to be specified by the next setting operation based on the topic output from the machine learning model M and the topic database DB2. For example, the setup support module 203 suggests to the user a field setting that the user has not yet specified among the field settings used in the topic to which the app being set by the user belongs.

For example, when the field setting is a field type, the setup support module 203 supports the setting up by suggesting to the user the field type to be specified by the next setting operation based on the field types specified by the setting operations and the machine learning model M. The setup support module 203 suggests to the user a field type that the user has not yet specified among the field types used in the topic to which the app being set by the user belongs.

For example, the setup support module 203 executes clustering of the app being set by the user based on the settings specified by the setting operations and the machine learning model M. The setup support module 203 expresses the current settings specified by the user in the same format as that of the training data. In the example of FIG. 6, the setup support module 203 expresses the current settings specified by the user as data having a vector format. The setup support module 203 executes clustering of the app being set by the user by inputting the data to the machine learning model M. The machine learning model M outputs the topic ID of the topic to which the app being set belongs.

The setup support module 203 identifies the topic to which the app being set by the user belongs based on the execution result of clustering. The topic is identified based on the topic ID output by the machine learning model M. The setup support module 203 supports the setting up by predicting the next setting operation (the next setting to be specified by the user, that is, the recommended setting) based on the settings of the training apps belonging to the topic. For example, the next setting operation is predicted from the trend of apps similar to the app being set (apps belonging to the same topic as that of the app being set).

For example, the setup support module 203 refers to the topic database DB2 and acquires the topic data of the topic to which the app being set by the user belongs. The setup support module 203 predicts the field setting to be specified next based on the acquired topic data and the current field settings of the app being set by the user. The setup support module 203 predicts, based on the topic data, a field setting that is insufficient in the current field settings of the app being set by the user, as the field setting to be specified by the next setting operation.

For example, when the user has not yet specified a field type having a relatively high usage rate indicated by the topic data, the setup support module 203 suggests a relevant field type to the user. Even in a case in which the user has specified a field type having a relatively high usage rate indicated by the topic data, when that field type is relatively rare for the app being set, the setup support module 203 suggests a relevant field type to the user. The setup support module 203 may calculate an evaluation value by using a predetermined formula based on the field type specified for the app being set and the usage rate of each field type indicated by the topic data, and suggest a field type having a relatively high evaluation value to the user.

In the example of FIG. 4, when it is assumed that the usage rate of the field type “numerical value” and the usage rate of the field type “calculation” are relatively higher than the usage rates of other field types in the topic data of the topic to which the app being set by the user belongs, in that case, when the user specifies two fields of the field type “numerical value” for the app being set, based on processing by the machine learning model M, the setup support module 203 identifies that the app being set belongs to the above-mentioned topic. The setup support module 203 then identifies, based on the topic data, that the usage rate of the field type “calculation,” which the user has not specified yet, is high, and as illustrated in the lower part of FIG. 4, suggests the field having the field type “calculation” to the user.

The setup support module 203 may suggest a field setting other than a field type to the user. For example, when the machine learning model M has learned a trend of another field setting, such as field name, the setup support module 203 may suggest the another field setting to the user. When the machine learning model M has learned a trend of another setting other than a field setting (for example, graph setting), the setup support module 203 may suggest the another setting to the user.

Further, in the at least one embodiment, a case in which processing is executed by the setup support module 203 every time the user performs some sort of setting operation is given as an example, but the setup support module 203 is not required to execute processing every time there is a setting operation. For example, the setup support module 203 may execute the processing every time the user performs the setting operation a predetermined number of times (for example, three times). The setup support module 203 may execute processing when the user performs an operation to request support from the machine learning model M. The setup support module 203 may also be configured to not make a suggestion to the user when the machine learning model M cannot predict a setting to be suggested.

### 3-3. Functions Implemented by User Terminal

For example, the user terminal 30 includes a data storage unit 300, a display control module 301, and an operation receiving module 302. The data storage unit 300 is implemented by the storage unit 32. Each of the display control module 301 and the operation receiving module 302 is implemented by the control unit 31.

### Data Storage Unit

The data storage unit 300 stores data required in order to set the settings of the app. For example, the data storage unit 300 stores a browser for displaying various screens of the setup support system 1. For example, the data storage unit 300 stores a program dedicated to groupware.

### Display Control Module

The display control module 301 displays various screens of the setup support system 1 on the display unit 35. For example, the display control module 301 displays a screen such as the app screen SC1 or the setting screen SC2 on the display unit 35 based on the data received from the server 20.

### Operation Receiving Module

The operation receiving module 302 receives various operations performed in the setup support system 1. For example, an operation on the app screen SC1 or the setting screen SC2 is received. Data indicating the operation content received by the operation receiving module 302 is transmitted to the server 20 as appropriate.

### 4. Processing Executed by Setup Support System

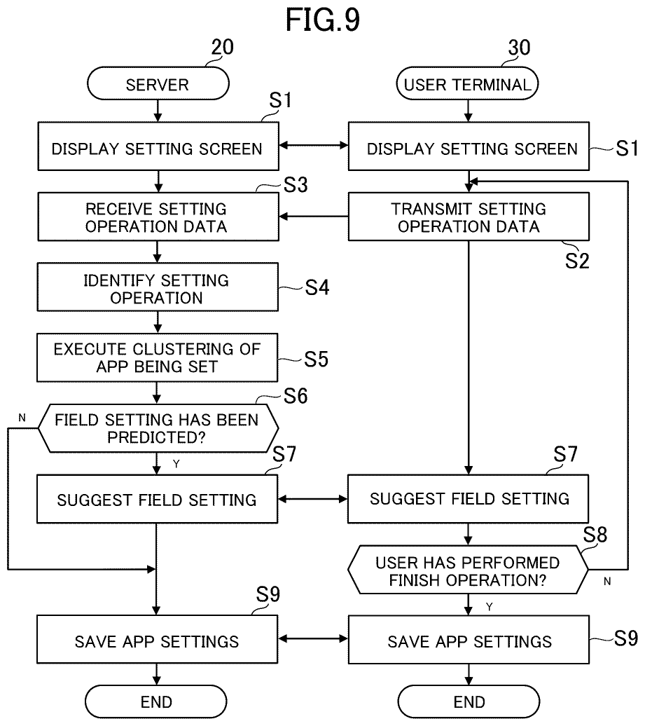

FIG. 9 is a flow chart for illustrating an example of processing executed by the setup support system 1. The processing of FIG. 9 is executed by the control units 21 and 31 executing the programs stored in the storage units 22 and 32, respectively. It is assumed that the training of the machine learning model M is complete when the processing of FIG. 9 is executed. The processing of FIG. 9 is an example of the processing in the setup support method of the at least one embodiment.

As illustrated in FIG. 9, when the user performs an operation to create a new app, the user terminal 30 executes, together with the server 20, processing for displaying the setting screen SC2 (Step S1). When the user performs some sort of setting operation on the setting screen SC2, the user terminal 30 transmits setting operation data indicating the setting operation by the user to the server 20 (Step S2). The server 20 receives the setting operation data from the user terminal 30

(Step S3). The server 20 identifies the setting operation by the user based on the setting operation data (Step S4). The server 20 records data indicating a history of setting operations by the user in the storage unit 22. That is, the server 20 records, in the storage unit 22, data indicating what kind of field settings have been specified for the app being set.

The server 20 executes clustering of the app being set by the user based on the field settings specified by the user in the setting operations up to now and the machine learning model M (Step S5). In Step S5, the server 20 executes clustering by generating data expressing the field settings specified by the user in the same vector format as that of the training data and inputting the generated data to the machine learning model M. The server 20 determines, based on the execution result of clustering in Step S5 and the topic database DB2, whether or not the field setting (recommended field setting) to be specified by the next setting operation has been predicted (Step S6). When the user has just started specifying the field settings, the topic to which the app being set belongs may not be identified, and hence in this case, a field setting is not predicted.

In Step S6, when it is determined that the field setting to be specified by the next setting operation has been predicted (“Y” in Step S6), the server 20 executes, together with the user terminal 30, processing for suggesting the identified field setting (Step S7). In Step S7, the server 20 transmits to the user terminal 30 data indicating the field setting to be suggested. Based on the data, the user terminal 30 suggests the field setting to the user by using a placeholder function or the like. In Step S6, when it is not determined that the field setting to be specified by the next setting operation has been predicted (“N” in Step S6), the processing step of Step S7 is not executed. The user terminal 30 determines whether or not the user has performed a finish operation to finish setting the app (Step S8). The finish operation may be any operation performed from the setting screen SC2 (for example, an operation in which the user selects an “update” button).

In Step S8, when it is not determined that the user has performed a finish operation (“N” in Step S8), the process returns to Step S2. In this case, setting the app continues. In Step S8, when it is determined that the user has performed a finish operation (“Y” in Step S8), the user terminal 30 executes, together with the server 20, processing for saving the app settings in the app database DB3 (Step S9), and the processing ends. In Step S9, the user terminal 30 transmits final setting data indicating the final settings of the app to the server 20. The server 20 generates a new app ID and app setting data corresponding to the final setting data, and stores the new app ID and app setting data in the app database DB3. When the processing step of Step S9 is complete, the app created by the user is used by the organization of the user. The above-mentioned processing is complete without the user inputting code.

### 5. Summary of at Least One Embodiment

The setup support system 1 of the at least one embodiment can support the user to set up the app based on the setting operations performed by the user and a machine learning model M which has learned training data. The support by the setup support system 1 reduces the burden of the setting up on the user. For example, it is possible for a user to obtain general information, such as how to use an app in general, from the help page of the app, but it may not be possible for the user to obtain information specific to the app that the user is currently setting. In this regard, the setup support system 1 can implement support tailored to individual users by using the machine learning model M. The setup support system 1 can also motivate users who are considering using an app to start using the app. For example, users who have never used an app may hesitate to use the app because such users do not know what settings to specify. In this regard, the support by the setup support system 1 makes it easier for the user to start using the app. As a result, the setup support system 1 can promote the use of the app.

Further, the setup support system 1 supports the setting up based on the settings specified by a setting operation and the machine learning model M. As a result, the setup support system 1 can implement more effective support by using the machine learning model M to analyze the specific settings specified by the user.

Further, the setup support system 1 supports the setting up by suggesting to the user the field setting to be specified by the next setting operation based on the field settings specified by the setting operations and the machine learning model M. The field settings are particularly important settings for an app, and are complex settings that in particular beginner users tend to have trouble with. For this reason, users often find it difficult to choose the field settings, but the setup support system 1 can implement more effective support by using the machine learning model M to analyze the field settings specified by the user.

Further, the setup support system 1 supports the setting up by suggesting to the user the field type to be specified by the next setting operation based on the field types specified by the setting operations and the machine learning model M. For example, beginner users tend to have trouble with specification of the field types, but the setup support system 1 can implement more effective support by using the machine learning model M to analyze the field types specified by the user at the current point, and suggesting the next field type to the user.

Further, the setup support system 1 executes clustering of the app being set based on the settings specified by the setting operations and the machine learning model M, and supports the setting up based on the execution result of the clustering. As a result, the setup support system 1 can support the setting up based on the trend of a training app similar to the app being set. For example, the user can continue setting up the app while referring to the settings of a training app similar to the app the user is trying to create.

### 6. Modification Examples

The present disclosure is not limited to the example of the at least one embodiment described above, and can be modified suitably without departing from the spirit of the present disclosure.

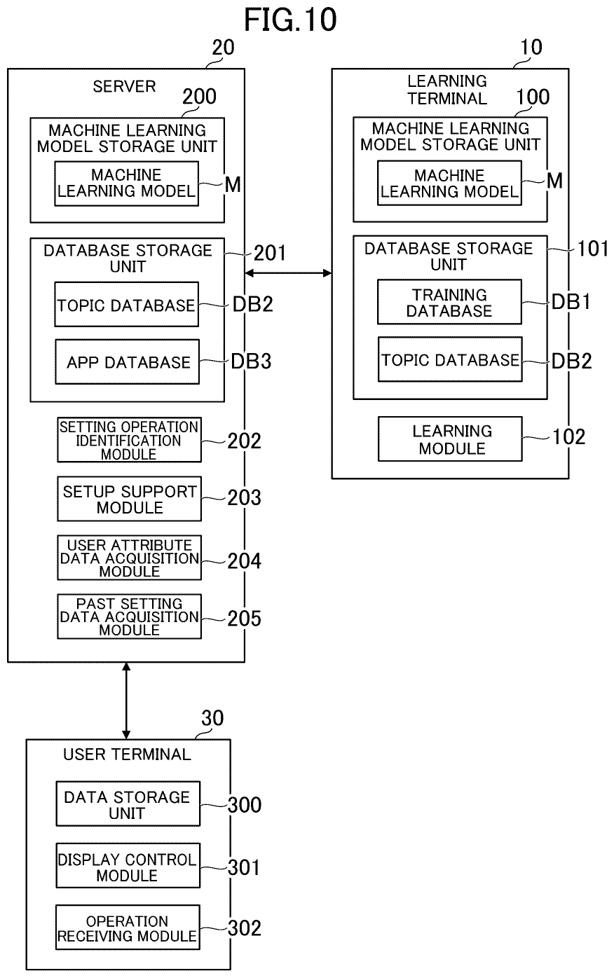

FIG. 10 is a diagram for illustrating an example of functions implemented by a setup support system 1 of the modification examples. As illustrated in FIG. 10, in the modification examples described below, the server 20 includes a user attribute data acquisition module 204 and a past setting data acquisition module 205. Each of the user attribute data acquisition module 204 and the past setting data acquisition module 205 is implemented by the control unit 21.

### 6-1. Modification Example 1

For example, in the at least one embodiment, the field type is mainly described as an example of a field setting, but the field setting may be other settings of the field. In Modification Example 1, a case in which the field setting is a field layout, which is the layout of the fields, is given as an example. The layout is the position of the fields in the app. For example, the field order (column order) in the app or the position of the form of the field in the app screen SC1 of the lower part of FIG. 2 corresponds to the field layout.

For example, the user can perform a setting operation for specifying the field layout from the setting screen SC2. In the examples of FIG. 3 and FIG. 4, the field order in the app may be such that the field of the form at the top left of the display area A21 is number 1, and the order decreases as you go to the right and down. The positions of the forms of the fields on the app screen SC1 may be the same as the position of the forms of the fields in the display area A21. The setting operation for specifying the field layout may be any other operation. For example, the setting operation in Modification Example 1 may be an operation in which the user inputs numerical values indicating the order of the fields, an operation in which the user rearranges the order of the fields from a list similar to the record list L10, or another operation.

The setup support module 203 in Modification Example 1 supports the setting up by suggesting to the user the field layout to be specified by the next setting operation based on the field layouts specified by the setting operations and the machine learning model M. The training data in Modification Example 1 is created based on the field layout of a training app. For example, the training data indicates the order (for example, the order of numerical value, numerical value, calculation) of the fields in the training app or the position (for example, the position of the forms of the fields of each of the numerical value, numerical value, calculation field types) of the forms of the fields.

For example, the learning module 102 in Modification Example 1 trains the machine learning model M based on training data created based on the field layout of the training app. The learning module 102 trains the machine learning model M so that training apps having a similar field layout belong to the same topic. The learning module 102 generates a topic database DB2 in which topic data indicating trends in field layouts of training apps belonging to each topic is stored. For example, the topic data stored in the topic database DB2 in Modification Example 1 shows a trend of the field layout of the training apps belonging to the topic. For example, the topic data of a certain topic indicates the order of the fields of the training apps belonging to the topic or the arrangement of the forms of the fields of the training apps belonging to the topic.

For example, the setup support module 203 identifies the topic to which the app being set belongs based on the machine learning model M based on the field layout of the app being set. The setup support module 203 inputs data indicating the field layout of the app being set to the machine learning model M. The machine learning model M executes clustering based on the data, and identifies the topic to which the app being set belongs. The data used in the clustering is different from that in the at least one embodiment, but the clustering processing is the same as in the at least one embodiment.

For example, the setup support module 203 predicts the field layout to be specified by the next setting operation based on the topic data of the topic to which the app being set belongs. For example, in the example of the setting screen SC2 of the lower part of FIG. 4, the topic data shows the trend in which two fields of the field type “numerical value” are arranged horizontally and a field of the field type “calculation” is arranged further horizontally to those. In this case, the setup support module 203 predicts that when the user horizontally arranges two fields of the field type “numerical value,” some sort of field will be arranged next further horizontally to those. The setup support module 203 suggests to the user to arrange a field further horizontally to those fields.

The setup support module 203 may determine whether or not the field layout specified by the user for the app being set is different from the field layout indicated by the topic data of the topic to which the app being set belongs. When it is determined that those field layouts are different, the setup support module 203 may suggest to the user the field layout indicated by the topic data.

For example, in an app like that illustrated in FIG. 2 to FIG. 4, the user may have specified, as the first three fields in the app being set, a field of the field type “calculation,” a field of the field type “numerical value,” and a field of the field type “numerical value” in that order. In this case, in the topic data of the topic to which the app being set belongs, the indicated field order of the first three fields may be a field of the field type “numerical value,” a field of the field type “numerical value,” and a field of the field type “calculation.” In this case, the setup support module 203 determines that those field orders are different, and thus suggests to the user the order indicated by the topic data.

For example, the setup support module 203 determines whether or not the position of the form of each field in the display area A21 of the app being set is different from the position of the form of each field indicated by the topic data of the topic to which the app being set belongs. When the setup support module 203 determines that those positions are different and that the difference between those positions (for example, difference in the two-dimensional position of the forms) is equal to or more than a threshold value, the setup support module 203 suggests to the user the position of the form of each field indicated by the topic data. When another element is used as the field layout, the setup support module 203 may suggest the another element to the user.

The setup support system 1 of Modification Example 1 supports the setting up by suggesting to the user a field layout to be specified by the next setting operation based on the field layouts specified by the setting operations and the machine learning model M. For example, users who are not familiar with creating apps may not fully understand what kind of field layout is appropriate, and may find it difficult to specify the field layout. The setup support system 1 can implement more effective support by using the machine learning model M to analyze the field layout specified by the user and suggesting a field layout to the user.

### 6-2. Modification Example 2

For example, the setup support module 203 may suggest to the user a training app similar to the app being set. Similar to the at least one embodiment, the machine learning model M in Modification Example 2 has learned training data created based on a training app. The setup support module 203 in Modification Example 2 supports the setting up by suggesting a training app to the user based on the settings specified by the setting operations and the machine learning model M. The training app to be suggested is a training app which belongs to the same topic as that of the app being set.

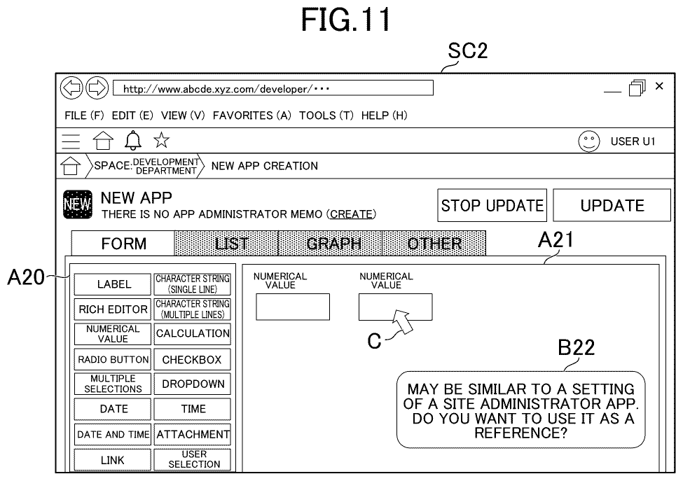

FIG. 11 is a diagram for illustrating an example of the setting screen SC2 in Modification Example 2. For example, in the same manner as in the at least one embodiment, the setup support module 203 identifies the topic to which the app being set belongs. The setup support module 203 selects one of a plurality of training apps belonging to the topic. The setup support module 203 may randomly select any one of the plurality of training apps, or select a representative training app (for example, a training app specified by the creator of the machine learning model M) within the topic. As illustrated in FIG. 11, the setup support module 203 causes the user terminal 30 to display a button B22 for displaying the settings of the training app on the setting screen SC2.

For example, when the user selects the button B22, the setup support module 203 causes the user terminal 30 to display the setting screen SC2 showing the settings of the training app. In the example of FIG. 11, the setup support module 203 refers to the app database DB3 and acquires app setting data of a training app “site administrator app” which is similar to the app being set. The setup support module 203 displays all or a part of the acquired app setting data on the setting screen SC2. The user continues the setting up of the app being set by referring to the settings of the training app. The user replaces the settings of the app being set with the settings of the training app displayed on the setting screen SC2 as required. In place of the app being set, the user may create a new app by copying the training app.

The setup support system 1 of Modification Example 2 supports the setting up by suggesting a training app to the user based on the settings specified by the setting operations and the machine learning model M. As a result, the user can perform the setting up by referring to the training app, and thus the setup support system 1 can improve convenience for the user.

### 6-3. Modification Example 3

For example, the machine learning model M may have learned training data indicating settings specified by training setting operations and the order in which the training setting operations have been performed. The training data in Modification Example 3 indicates not only the number of field types as described in the at least one embodiment, but also the order of the setting operations when the training app settings were set. For example, the order of the setting operations is also indicated in the training data, such as a first setting operation indicating a field of the field type “numerical value,” a second setting operation indicating a field of the field type “numerical value,” and a third setting operation indicating a field of the field type “calculation.” The training data may indicate the order in which setting operations such as field deletion were performed.

For example, even when two fields of the field type “numerical value” are specified and one field of the field type “calculation” is specified, the next setting operation may differ depending on the order in which those fields are specified. For example, when fields are specified in the order of numerical value, numerical value, calculation, numerical value is often specified next, but when fields are specified in the order of numerical value, calculation, numerical value, in many cases calculation is specified next. Thus, the machine learning model M may learn not only the simple number of field types but also the trend of the order in which the field types are specified. The machine learning model M executes clustering by considering not only the number of field types but also the order of setting operations as one of the features. For this reason, even when the number of field types is the same, training apps having a different order of setting operations may belong to different topics.

The setup support module 203 in Modification Example 3 supports the setting up based on the settings specified by the setting operations, the order in which the setting operations have been performed, and the machine learning model M. For example, the setup support module 203 inputs to the machine learning model M not only the settings indicated by the setting operations performed by the user on the app being set, but also data indicating the order in which those setting operations have been performed. The machine learning model M executes clustering by considering the order as one of the features. The setup support module 203 suggests to the user the field type to be specified by the user next based on the execution result of clustering by the machine learning model. The point that consideration is given to the order in clustering is different from the at least one embodiment, but the processing after clustering is executed (processing for suggesting a field type) is the same as in the at least one embodiment.

The setup support system 1 of Modification Example 3 supports the setting up based on the settings specified by the setting operations, the order in which the setting operations have been performed, and the machine learning model M. As a result, the setup support system 1 can implement more effective support when the suggestion to the user is different depending on the order of the setting operations. For example, even when two fields of the field type “numerical value” are specified and one field of the field type “calculation” is specified, the setup support system 1 can give an appropriate suggestion to the user by suggesting a different field type to the user when the field types have been specified in the order of numerical value, numerical value, calculation from the field type to be suggested to the user when the field types have been specified in the order of numerical value, calculation, numerical value.

### 6-4. Modification Example 4

For example, the machine learning model M is not limited to a model which executes clustering as described in the at least one embodiment. In Modification Example 4, another example of the machine learning model M is described. The machine learning model M in Modification Example 4 is an interactive model. An interactive model is a model in which when a user inputs natural language text, a response is generated in accordance with the text. The text input by the user includes content relating to the settings of the app. For example, the user inputs text about the purpose of the app or desired general app settings. An interactive model can also be referred to as “chat model.”

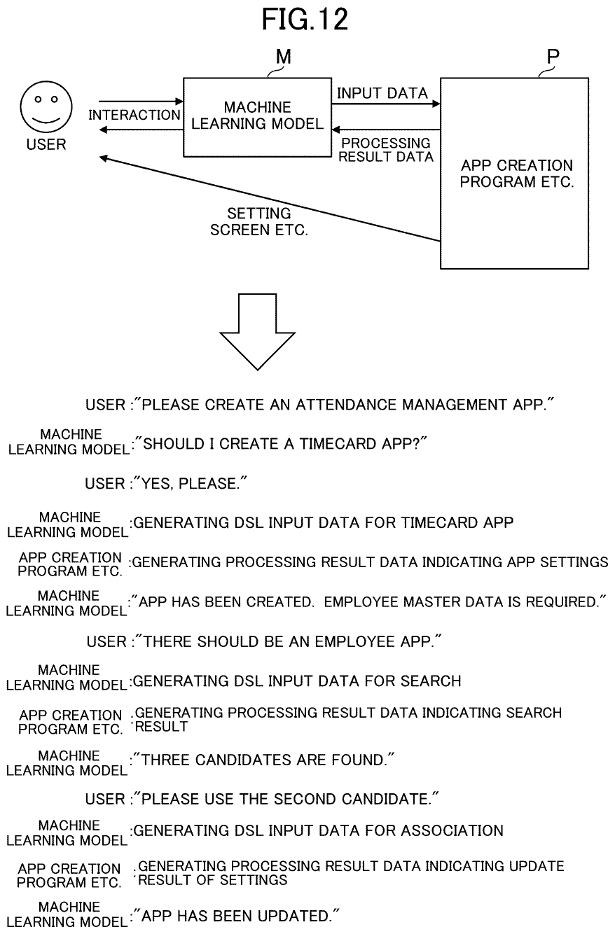

FIG. 12 is a diagram for illustrating an example of processing executed by the setup support system 1 of Modification Example 4. As illustrated in FIG. 12, for example, when a user inputs text such as “Please create an attendance management app,” the machine learning model M divides the text into tokens and calculates an embedded expression. The machine learning model M generates a response “Should I create a timecard app?” in accordance with the embedded expression.

For example, when the user inputs text such as “Yes, please,” the machine learning model M generates data for a domain-specific language (DSL), which is a type of a programming language or markup language for a specific purpose, based on a trend of a training timecard app. In Modification Example 4, the DSL generated by the machine learning model M is data having a format that can be input to an app creation program P that creates an app. The app creation program P creates an app based on the DSL. For example, the app creation program P includes processing code for generating app setting data from the data of the DSL generated by the machine learning model M. The app creation program P is stored in the data storage unit 200. The server 20 executes the code shown in the app creation program P, which causes the app creation program P to implement no-code or low-code app creation. When the computer in which the machine learning model M is stored and the computer in which the app creation program P is stored are separate, the app creation program P may be a part of an API. A program other than the app creation program P may be used for app creation.

For example, when the app creation program P creates a temporary app, the machine learning model M acquires from the app creation program P processing result data indicating the processing result of the app creation program P. The processing result data may have any format, for example, data in a markup language such as JSON. For example, data indicating the settings of the temporary app created by the app creation program P is acquired as the processing result data. The processing result data may indicate the type of data required for the app (for example, employee master data). The machine learning model M generates a response “App has been created. Employee master data is required” to the user based on the processing result data. When the user inputs text such as “There should be an employee app,” the machine learning model M generates DSL data that allows the app creation program P to search for the employee app specified by the user.

For example, when the app creation program P searches for an app based on the DSL data, the app creation program P generates processing result data indicating the search results for the app. When the processing result data shows that three apps were found in the search, the machine learning model M displays a message such as “Three candidates are found,” and prompts the user to choose one of those three apps. When the user inputs text such as “Please use the second candidate,” the machine learning model M generates DSL data indicating that the employee master data from the second app is to be associated. The app creation program P acquires the employee master data from the second app based on the DSL data, and updates the app setting data of the app being set. The machine learning model M acquires processing result data indicating the update result of the app setting data from the app creation program P. The machine learning model M displays a response “The app has been updated” to the user based on the processing result data. In Modification Example 4, the user can complete the setting of the app through such interaction.

In Modification Example 4, a case in which the machine learning model M is a so-called large language model is given as an example. For example, the machine learning model M may be a large language model such as a Generative Pre-trained Transformer (GPT), a Bidirectional Encoder Representation from a Transformer (BERT), a Pathways Language Model (PaLM), or a Large Language Model Meta AI (LLAMA). The machine learning model M may be another model that is not classified as a large language model (for example, a neural network or a sequence-to-sequence model). For example, the parameters of the machine learning model M may be a matrix referred to at the time of calculating an embedded expression, position encoding referred to in the encoding of the token position, or other parameters.

For example, the program of the machine learning model M includes an encoder which calculates an embedded expression, a decoder which creates data for output corresponding to a task such as schedule adjustment, an output layer which performs final output based on the data, and processing for other intermediate layers. When the machine learning model M is a large language model, the machine learning model M also includes a program including processing of dividing data which has been input into a plurality of tokens. The program of the machine learning model M may be a publicly-known program. When the machine learning model M is a large language model, the machine learning model M also includes a program including processing of dividing data which has been input into a plurality of tokens.

In Modification Example 4, a case in which a large language model that has been trained in advance corresponds to the machine learning model M is given as an example. For example, the learning module 102 may retrain the machine learning model M based on training data. Retraining is adjusting the parameters of the machine learning model M that has been trained in advance. For example, retraining is fine tuning, transfer learning, or distillation. In place of retraining the machine learning model M, the learning module 102 may perform training from scratch on a machine learning model M that has not been trained in advance (a machine learning model M in which the parameters are initial values).

The training data in Modification Example 4 includes an input portion which is input to the machine learning model M during training, and an output portion which becomes a ground truth during training. For example, the input portion of the training data is text input by the user for training. The output portion of the training data is DSL data that becomes the ground truth when the text is input. The learning module 102 adjusts the parameters of the machine learning model M so that when the text indicated by the input portion of the training data is input, the DSL data indicated by the output portion of the training data is output.

For example, the input portion of the training data may be processing result data for training generated by the app creation program P. The output portion of the training data may be text that becomes the ground truth in a response to the user. The learning module 102 adjusts the parameters of the machine learning model M so that when the processing result data indicated by the input portion of the training data is input, the text indicated by the output portion of the training data is output.

The setting operation in Modification Example 4 is an operation in which the user inputs a prompt to the machine learning model M in order to set the settings of the app. A prompt is an instruction from the user to the machine learning model M. As illustrated in FIG. 12, in the case of an interactive machine learning model M, the prompt is basically input as text, but the prompt may also include symbols, for example, indicating some sort of instruction in addition to text. The setup support module 203 supports the setting up by acquiring input data having a format that can be input to the app creation program P which creates the app, based on the prompt input by the setting operation and the machine learning model M. In the example of FIG. 12, the data generated by the DSL corresponds to input data.

For example, the machine learning model M divides the prompt input by the user in a setting operation into a plurality of tokens. The machine learning model M calculates an embedded vector for each of the plurality of tokens based on the trained parameters. The machine learning model M predicts the next word as required based on the calculated embedding vector, and then generates input data. The input data includes information for the settings in accordance with the prompt input by the user. Depending on the prompt input by the user, the machine learning model M may not generate input data.

The setup support module 203 in Modification Example 4 inputs the output data output from the machine learning model M to the app creation program P as input data. The setup support module 203 supports the setting up by causing the app creation program P to output processing result data indicating the processing result of the app creation program P. For example, the app creation program P executes processing for setting the app based on input data input to the app creation program P. The app creation program P generates and outputs processing result data based on own code in the app creation program P. The setup support module 203 supports the setting up by presenting the user with a response to the prompt based on the processing result data acquired from the app creation program P and the machine learning model M. In the example of FIG. 12, the result of processing by the app creation program P is illustrated as processing result data having JSON format.

For example, the setup support module 203 inputs the processing result data to the machine learning model M. The machine learning model M divides data into tokens as required based on the processing result data, and then calculates an embedded vector. The machine learning model M generates response data corresponding to the embedded vector. The setup support module 203 transmits the data to the user terminal 30, thereby causing the user terminal 30 to display the response by the machine learning model M. The setup support module 203 may support the setting up by causing the user terminal 30 to display the content of the processing result data as it is, rather than causing the machine learning model M to generate a response based on the processing result data. In this case, the user can check the content of the processing result data having JSON format.

The setup support module 203 in Modification Example 4 may determine whether the output data output from the machine learning model M has a format that can be input to the app creation program P. In the case of FIG. 12, the setup support module 203 determines whether the output data output from the machine learning model M has the DSL format. In this case, when it is determined that the output data has the DSL format, the setup support module 203 supports the setting up by acquiring the output data as input data. When it is not determined that the output data has the DSL format, the setup support module 203 supports the setting up by presenting the user with a response to the prompt based on the output data.

In the example of FIG. 12, for the first prompt input by the user, the output data is not output in the DSL format, and thus the response to the user is displayed without the input data being input to the app creation program P. As illustrated in FIG. 12, the setting of the app is completed through repeated interactions between the user and the machine learning model M. It is noted that the interaction until the setting of the app is completed may be performed only once. In this case, the setting of the app is completed without repeating interaction. The setting of the app may be completed when the user performs an operation to finish the setting of the app.

The setup support system 1 of Modification Example 4 supports the setting up by acquiring input data having a format that can be input to the app creation program P, based on the prompt input by the setting operation and the machine learning model M. As a result, the setup support system 1 can complete the setting of the app without causing the user to specify the app settings themselves. For example, the user is only required to input a rough outline of the desired app as a prompt, and thus the setup support system 1 can implement more effective support.

Further, the setup support system 1 supports the setting up by inputting the output data output from the machine learning model M to the app creation program P as input data, and causing the app creation program P to output processing result data indicating the processing result of the app creation program P.

The setup support system 1 eliminates the requirement for the user to directly specify the settings for causing the app creation program P to output processing result data by causing the app creation program P to output processing result data by using the machine learning model M, and thus user convenience can be effectively improved. As a result, the setup support system 1 can improve the accuracy of the app.

Further, when it is determined that the output data output from the machine learning model M has a predetermined format, the setup support system 1 supports the setting up by acquiring the output data as input data. When it is not determined that the output data has a predetermined format, the setup support system 1 supports the setting up by presenting the user with a response to a prompt based on the output data. Thus, even when the setup support system 1 does not achieve the desired settings based on the first interaction, the settings can be corrected by repeating the interaction. As a result, the setup support system 1 can improve the accuracy of the app. For example, the setup support system 1 can continue interacting with the user even when the machine learning model M cannot output the output data having a format required to set the app. The setup support system 1 can output the output data having a predetermined format while continuing the interactions with the user.

### 6-5. Modification Example 5

For example, the content that is better to suggest to the user may differ depending on the organization or department to which the user belongs. In the example of FIG. 4, even when the user places two fields of the field type “numerical value,” the field type that is better to be suggested next by the setup support system 1 may be different when the user belongs to a manufacturing company from when the user belongs to a services company. For example, the field type better to be suggested next by the setup support system 1 may be different when the user belongs to the sales department from when the user belongs to the development department. For this reason, the setting up may be supported by taking a given attribute of the user into consideration.

The setup support system 1 of Modification Example 5 includes the user attribute data acquisition module 204. The user attribute data acquisition module 204 acquires user attribute data indicating user attributes. The user attribute data is stored in the database storage unit 201. The user attributes may be any information that can be used to classify the user from some sort of viewpoint. For example, in addition to the industry type or department of the organization described above, the attributes may be an age group, a gender, years of service, a position, a hobby, or another attribute of the user. The user attributes may be specified by the user or by an administrator in the organization of the user.

The setup support module 203 in Modification Example 5 supports the setting up based on the setting operations, the machine learning model M, and the user attribute data. In Modification Example 5, the training data includes user attribute data of users for training. For example, the training data includes not only the settings of the training app but also user attribute data of the user for training who created the training app. The machine learning model M executes clustering by considering not only the settings of the training app but also the user attribute data of the user for training who created the training app as one of the features. The setup support module 203 supports the setting up based on the execution result of clustering, which also includes the user attribute data as one feature. In Modification Example 5, the point that a user attribute is taken into consideration when clustering is executed is different from the at least one embodiment, but the processing after clustering is executed (processing for suggesting a field type) is the same as in the at least one embodiment.

The setup support system 1 of Modification Example 5 supports the setting up based on the setting operations, the machine learning model M, and the user attribute data. As a result, the setup support system 1 can give suggestions corresponding to the attributes of the user, and hence can effectively support the setting up by the user.

### 6-6. Modification Example 6

For example, even when the user has set some sort of app in the past, the content that is better to suggest to the user may differ from the past trend of the user. For example, when it is assumed that the user has placed two fields of the field type “numerical value,” in a case in which the user tends to place one more field of the field type “numerical value” instead of a field of the field type “calculation” after that, then it is better to suggest a field of the field type “numerical value.” For this reason, the setting up may be supported by taking into consideration the trend of the settings performed by the user in the past.

The setup support system 1 of Modification Example 6 includes the past setting data acquisition module 205. The past setting data acquisition module 205 acquires past setting data indicating past settings, which are settings performed by the user in past setting operations. The user attribute data is stored in the database storage unit 201. For example, when the user performs a setting operation for some sort of app, the server 20 records past setting data corresponding to the settings indicated by the setting operations in the database storage unit 201 in association with the user ID of the user.

The setup support module 203 in Modification Example 6 supports the setting up based on the setting operations, the machine learning model M, and the past setting data. In Modification Example 6, the training data includes past setting data of users for training. For example, the training data includes not only the settings of the training app but also past setting data which indicates the setting performed in the past by the user for training who created the training app. The machine learning model M executes clustering by considering not only the settings of the training app but also the past setting data of the user for training who created the training app as one of the features. The setup support module 203 supports the setting up based on the execution result of clustering, which also includes the past setting data as one feature. In Modification Example 6, the point that the past trend of the user is taken into consideration when clustering is executed is different from the at least one embodiment, but the processing after clustering is executed (processing for suggesting a field type) is the same as in the at least one embodiment.

The setup support system 1 of Modification Example 6 supports the setting up based on the setting operations, the machine learning model M, and the past setting data. As a result, the setup support system 1 can give suggestions corresponding to the past trend of the user, and hence can effectively support the setting up by the user.

### 6-7. Other Modification Examples

For example, two or more of Modification Examples 1 to 6 may be combined.

For example, a case in which the setup support system 1 supports a user setting up a groupware app has been given as an example, but the setup support system 1 may support a user setting up a database other than an app. The setup support system 1 may support a user setting up a database that does not have a communication function, for example. The setup support system 1 may support a user setting up a database of a task support system that is not classified as groupware. The setup support system 1 may support a user setting up a database unrelated to a task support system. For example, a case in which the setup support system 1 supports a user setting up a new app has been given as an example, but the setup support system 1 may support a user performing setting up for changing the settings of an existing app. In this case as well, the setup support system 1 may support the setting up by the user based on the existing app settings, the setting operations performed by the user to change the settings, and the machine learning model M.

For example, in the at least one embodiment, a machine learning model M that performs clustering of apps is given as an example, but the machine learning model M may execute processing other than clustering. For example, the input portion of the training data may indicate a part of the settings of the training app. The output portion of the training data may indicate a setting to be specified next in the setting indicated by the input portion (a setting that becomes a ground truth). The learning module 102 trains the machine learning model M so that when the input portion indicating a part of the settings of the training app is input, the setting indicated by the output portion corresponding to the input portion is output. The setup support module 203 inputs, to the trained machine learning model M, the settings specified by the user in the app being set. The machine learning model M calculates an embedded expression of those settings based on the parameters adjusted by the learning, and outputs settings corresponding to the embedded expression. The setup support module 203 may suggest the settings output from the machine learning model M to the user. Those series of processing steps may be implemented by a mechanism in which a machine learning model M used in natural language processing predicts the next word.

For example, the functions described as being implemented by the server 20 may be implemented by the user terminal 30. In this case, the functions may be implemented by a browser script or an application installed on the user terminal 30. For example, each function may be shared by a plurality of computers or may be implemented by one computer.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A setup support system, comprising at least one processor, the at least one processor being configured to:
identify a setting operation performed by a user in order to set a setting of a database to be created with no-code or low-code; and
support setting up of the database by the user based on the setting operation and a machine learning model which has learned training data created based on a setting for training.

2. The setup support system according to claim 1,
wherein the setting operation is an operation for the user to specify a setting, and
wherein the at least one processor is configured to support the setting up based on the setting specified by the setting operation and the machine learning model.

3. The setup support system according to claim 2,
wherein the setting is a field setting which is a setting of a field in the database,
wherein the machine learning model has learned the training data created based on a field setting for training, and
wherein the at least one processor is configured to support the setting up by suggesting to the user the field setting to be specified by the next setting operation based on the field setting specified by the setting operations and the machine learning model.

4. The setup support system according to claim 3,
wherein the field setting is a field type which is a type of the field, and
wherein the at least one processor is configured to support the setting up by suggesting to the user the field type to be specified by the next setting operation based on the field type specified by the setting operation and the machine learning model.

5. The setup support system according to claim 3,
wherein the field setting is a field layout which is a layout of the field, and
wherein the at least one processor is configured to support the setting up by suggesting to the user the field layout to be specified by the next setting operation based on the field layout specified by the setting operation and the machine learning model.

6. The setup support system according to claim 2,
wherein the machine learning model has learned the training data created based on a database for training, and
wherein the at least one processor is configured to support the setting up by suggesting the database for training to the user based on the setting specified by the setting operation and the machine learning model.

7. The setup support system according to claim 2,
wherein the machine learning model has learned the training data created based on a database for training, and
wherein the at least one processor is configured to execute clustering of the database being set based on the setting specified by the setting operation and the machine learning model, and to support the setting up based on a result of execution of the clustering.

8. The setup support system according to claim 2,
wherein the machine learning model has learned the training data, which indicates settings specified by setting operations for training and an order in which the setting operations for training are performed, and
wherein the at least one processor is configured to support the setting up based on the settings specified by the setting operations, the order in which the setting operations are performed, and the machine learning model.

9. The setup support system according to claim 1,
wherein the machine learning model is an interactive model,
wherein the setting operation is an operation in which the user inputs a prompt to the machine learning model in order to set the setting, and
wherein the at least one processor is configured to support the setting up by acquiring input data having a format inputtable to a database creation program for creating the database based on the prompt input by the setting operation and the machine learning model.

10. The setup support system according to claim 9, wherein the at least one processor is configured to support the setting up by inputting output data output from the machine learning model to the database creation program as the input data, and causing the database creation program to output processing result data indicating a processing result of the database creation program.

11. The setup support system according to claim 9, wherein the at least one processor is configured to:
determine whether output data output from the machine learning model has the format;
support, when it is determined that the output data has the format, the setting up by acquiring the output data as the input data;
support, when it is not determined that the output data has the format, the setting up by presenting the user with a response to the prompt based on the output data; and
complete the setting through repeated interactions between the user and the machine learning model.

12. The setup support system according to claim 1, wherein the at least one processor is configured to:
acquire user attribute data indicating an attribute of the user; and
support the setting up based on the setting operation, the machine learning model, and the user attribute data.

13. The setup support system according to claim 1, wherein the at least one processor is configured to:
acquire past setting data indicating a past setting which is a setting performed by the user in a past setting operation; and
support the setting up based on the setting operation, the machine learning model, and the past setting data.

14. A setup support method, comprising:
identifying a setting operation performed by a user in order to set a setting of a database to be created with no-code or low-code; and
supporting setting up of the database by the user based on the setting operation and a machine learning model which has learned training data created based on a setting for training.

15. A non-transitory information storage medium having stored thereon a program for causing a computer to:
identify a setting operation performed by a user in order to set a setting of a database to be created with no-code or low-code; and
support setting up of the database by the user based on the setting operation and a machine learning model which has learned training data created based on a setting for training.
